(19) United States
(12) Patent Application Publication
(10) Pub. No.: US 2017/0124225 A1
(43) Pub. Date: May 4, 2017

(54) SIMULATION OF LARGE STRUCTURES

(71) Applicant: Microsoft Technology Licensing, LLC, Redmond, WA (US)

(72) Inventors: Dominic Humphrey, Redmond, WA (US); Christopher John David Cook, Sheffield (GB); Benjamin Paul Hinchliffe, Edinburgh (GB); Peter Jeffrey Cairns, Dundee (GB); Dónal Mac Carthy, Edinburgh (GB)

(21) Appl. No.: 14/928,936

(22) Filed: Oct. 30, 2015

(51) Int. Cl. G06F 17/50

(52) U.S. Cl. CPC G06F 17/5004

(57) ABSTRACT

A module state engine for simulating a large structure is configured to receive an input defining a force applied to a module in the large structure and in response, to update a mode associated with none, one or more of the modules in the large structure. The mode associated with a module is selected from: an inactive mode, a full simulation mode and one or more proxy modes. In inactive mode, a rigid body representation of an entire module is not animated. In full simulation mode the tiles within the module are simulated individually. In the fracture proxy mode, the rigid body representation of the entire module is not animated but a tile within the module can fracture into chunks, and in the simulation proxy mode, the module is simulated as a single rigid body and tiles within the module cannot fracture into chunks.

### BACKGROUND

Computer simulation of large-scale destruction, such as the destruction of an entire building or group of buildings, is computationally expensive because of the large number of objects (e.g. individual fragments) involved. In many examples, more objects are required in order to achieve realistic destruction than can be handled on a single compute device.

Furthermore, when the simulation is rendered on multiple client devices (e.g. in the case of large-scale destruction within a multi-player game) it is necessary to keep all the clients synchronized so that the simulation seen by each user is the same. It is not possible just to initiate the simulation independently on each client with the same input parameters and then assume that the simulation will proceed identically on each client because physics simulations are not entirely predictable as the simulation involves non-deterministic timing and/or different hardware resulting in bit-wise errors in calculations.

To reduce the computational expense of the simulation, objects may be pre-fractured into pieces and hierarchical fracturing may be used (e.g. such that a part of an object comprises a plurality of sub-parts). In addition, or instead, in order to reduce the computational expense the scope of the simulation may be reduced (e.g. by reducing the visible detail during the simulation and/or limiting the simulation to a user's field of view). Either of both of these techniques may also result in a reduction in the bandwidth required for synchronization in multi-user applications.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A module state engine for simulating a large structure is configured to receive an input defining a force applied to a module in the large structure and in response, to update a mode associated with none, one or more of the modules in the large structure based on the applied force and one or more of the module constraints. The mode associated with a module is selected from: an inactive mode, a full simulation mode and one or more proxy modes. In inactive mode, a rigid body representation of the entire module is not animated. In full simulation mode the tiles within the module are simulated individually. In the fracture proxy mode, the rigid body representation of the entire module is not animated by the physics engine but a tile within the module can fracture into chunks, and in the simulation proxy mode, the module is simulated as a single rigid body and tiles within the module cannot fracture into chunks.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows two graphical representations of a pre-fractured object;

FIG. 2 shows a graphical representation of a modified hierarchy as described herein;

FIG. 3 is a schematic diagram showing the transitions between modes;

FIG. 4 is a schematic diagram of an example system;

FIG. 5 is a flow diagram of an example method of operation of a module state engine and physics engine; and

FIG. 6 is a schematic diagram of another example system.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

As described above, simulation of large scale destruction is computationally expensive because of the large number of objects involved and the computational resources required may exceed the capabilities of a single compute device (e.g. a single server or a single games console). Furthermore this large number of objects requires a large bandwidth to synchronize clients in multi-user applications.

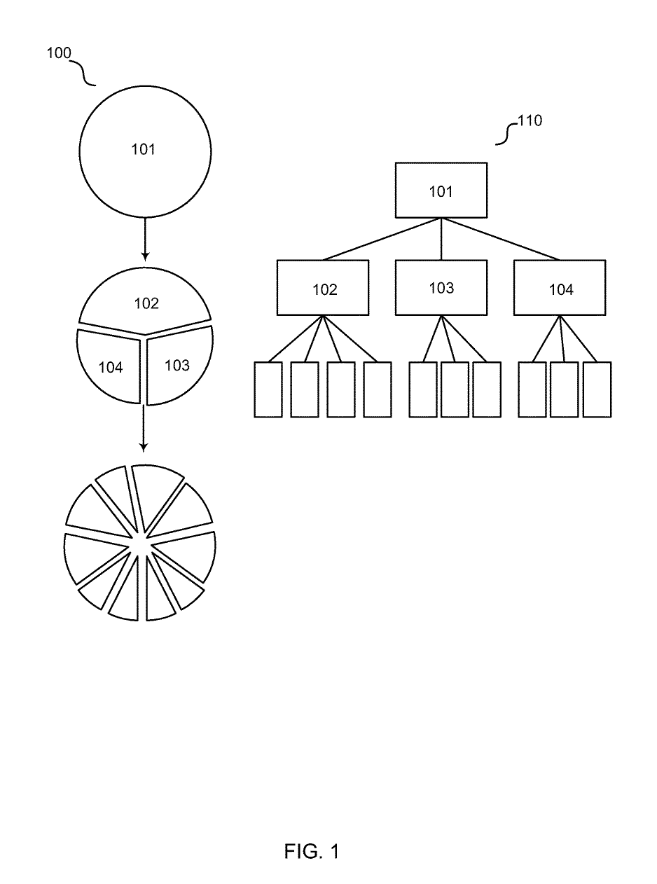

To reduce the computational expense of the simulation (and also the bandwidth required for synchronization, where performed) existing physics engines support use of pre-fractured objects and hierarchical fracturing may be used. The pre-fracturing of an object 101 is represented graphically in FIG. 1 in two different ways 100, 110. The first representation 100 shows the object 101 as a whole, then fractured into three pieces 102-104 and then further fractured into a total of 11 pieces. The second representation 110 is a tree diagram showing the hierarchy of the fragmentation of the object 101 into chunks (where the term ‘chunk’ or ‘sub-part’ is used to refer to a part of a fractured object). It is clear from the tree diagram that the object 101 is recursively pre-fractured into smaller chunks, with chunk 102 being pre-fractured into four smaller chunks, chunk 103 being pre-fractured into three smaller chunks and chunk 104 being pre-fractured into three smaller chunks. The top level object 101 (i.e. before any fracturing) which comprises a single mesh may be referred to as a ‘tile’. Whilst FIG. 1 shows only three levels in the tree diagram 110, it will be appreciated that the recursive pre-fragmentation may involve many more levels within the hierarchy and it will be appreciated that a typical pre-fractured object may comprise many more than 10 chunks at the lowest level (which corresponds to the smallest chunk sizes).

Large pre-fractured structures (i.e. structures which are pre-fractured into a large number of tiles, which collectively comprise more than a hundred chunks) are problematic, however, because they are unable to hold themselves together and eventually collapse under their own weight. Some physics engines also support linking of tiles to form larger structures; however, as each tile is pre-fractured, these structures also reach a threshold size where they are unable to hold themselves together and as a result collapse under their own weight.

The embodiments described below are not limited to implementations which solve any or all of the disadvantages of known methods and apparatus for computer simulation of large-scale destruction.

Systems and methods for simulating large structures (e.g. structures which are pre-fractured into a sufficiently large number of chunks that they cannot support their own weight in a conventional physics simulation, where such structures may, for example, comprise 5,000-10,000 chunks, 30,000-50,000 chunks or more than 100,000 chunks), and in particular for simulating the destruction of such structures, are described herein. As described in more detail below, the existing hierarchy of chunks (as shown in FIG. 1) is extended to further reduce compute and bandwidth requirements and to enable a much larger stable object. Tiles are logically grouped together and a group of tiles may be referred to as a ‘module’ and the large structure may comprise many modules. A proxy representation is provided for a module and this may be a combination of the ‘root’ pieces for each tile in the module (where the ‘root’ piece is the simplest, un-fractured shape at the top of the fracture hierarchy, e.g. object 101 in the example shown in FIG. 1). Alternatively, the proxy representation may be a single object or rigid body (i.e. it acts as a single chunk or fragment) with simplified geometry (i.e. compared to the sum of the component tiles within a module). Consequently, the proxy representation can be simulated with significantly reduced computational resources. Furthermore, bandwidth (e.g. between the physics engine and the game engine and between the game engine and the client) is significantly reduced because there is a single transform associated with the proxy representation and this eliminates the need during at least a part of the simulation, to synchronize data about each component tile and each chunk within a tile (e.g. as the number of chunks within a group of tiles forming a module will often exceed 1,000). Inter-module connections and constraints are also defined and these are described in more detail below.

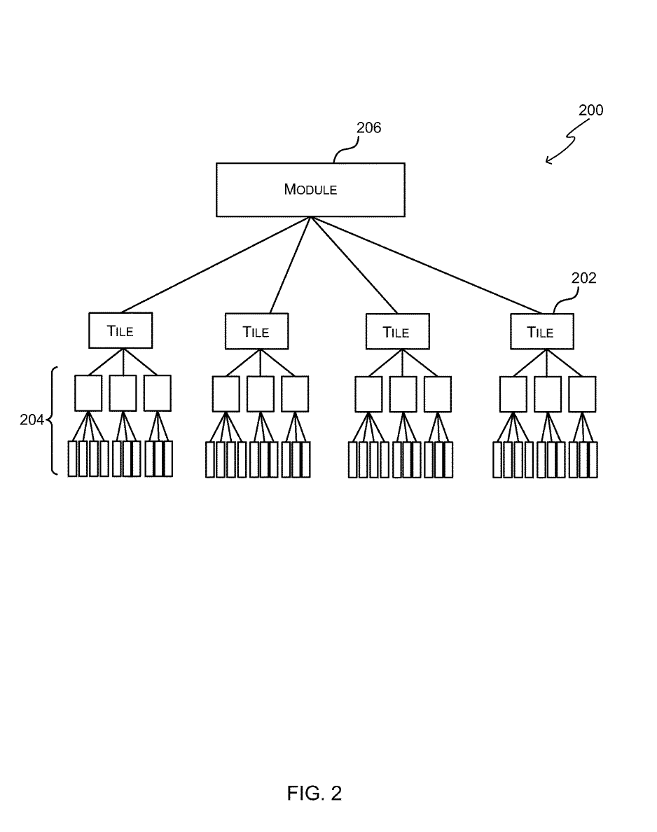

FIG. 2 provides a graphical representation of the modified hierarchy 200 and again, for purposes of explanation only, the number of tiles 202 and chunks 204 shown is massively reduced compared to typical simulations. As described above, the pre-fractured tiles 202 are logically grouped to form a module 206. A proxy representation is provided for each module 206, where this may be created in a number of different ways. For example, the proxy representation may be hand-authored by the user, or generated by an offline tool based on the full detail assets (i.e. the details of the tiles which form the module) or by combining the full detail assets at initialization time.

A large structure, such as a skyscraper, is formed from multiple modules, where a module may represent an entire floor or group of floors within the building. The tiles within a module may represent wall sections, floor sections, structural beams, etc. and these are pre-fractured in a conventional way. In order to provide additional rigidity to a collection of tiles, the module may also optionally comprise a superstructure to which all the tiles are logically attached. The superstructure is a collection of non-fracturing rigid bodies connected to each other and the tiles using whatever constraints the designer specifies (depending on how they would like the structure to behave).

Using the hierarchy shown in FIG. 2, data describing a module comprises the single rigid body representation of a group of tiles and references to each of the tiles contained within a module. The module data optionally comprises data describing the superstructure to which the pre-fractured tiles are attached. Inter-module connections and/or constraints are also defined and these may form part of the module data or may be stored separately. It will be appreciated that in defining any large structure, there may be multiple copies of the same module (e.g. multiple ‘floor’ modules) at different position in space (as specified within the transform for each instance of a module) and there may be multiple copies of the same pre-fractured tile within the same module and within different modules (e.g. multiple ‘wall section’ tiles, ‘floor section’ tiles, etc.).

A module can be in one of a plurality of modes (which may also be referred to as ‘states’) and in various examples there may be four possible modes for a module: inactive 302, full simulation 304 and two intermediate proxy simulation modes 306, 308. In other examples, however, there may be a single intermediate proxy simulation mode or there may be more than two intermediate proxy simulation modes, with each proxy simulation mode simplifying a different part of the simulation.

When a module is in the inactive mode 302 (which may be the starting mode for all modules), the proxy representation of the module (i.e. the single rigid body) can be collided with but no tile or chunk simulation occurs and no damage (e.g. fragmentation of the module) can happen. For example, if another object collides with the inactive module it can bounce away from the inactive module and potentially the impacting object can suffer damage; however, the inactive module does not suffer damage and the physics engine does not animate the module in any way when simulating the motion of the colliding object (e.g. it does not move and behaves as a fixed part of the environment). Use of this inactive mode reduces the number of calculations that need to be performed and avoids iterating through large numbers of inactive bodies setting redundant state every frame.

When a module is in the fracture proxy mode 306, the proxy representation of the module (i.e. the single rigid body) can be collided with but it is not animated and no tile or chunk simulation occurs. However, under pre-defined circumstances, the module can fracture into sub-parts (e.g. tiles or chunks) that are simulated such that small chunks can fracture off and separate away from the module (and these chunks can fracture further), whilst the rest of the module remains static.

When a module is in the simulation proxy mode 308, the proxy object (or proxy representation) is simulated (i.e. using the single rigid body representation of the module). In this mode, the module can be animated and can collide with other objects; however, the tiles cannot fracture into smaller pieces, detach from the rest of the building or move independently (although they will move as part of the module when the module moves) and consequently no damage (e.g. fragmentation of the module) can happen.

Whilst in either proxy mode 306, 308 the module is held up by any modules below it within a structure and hence the module holds up those modules above it, the individual tiles (which are pre-fractured) within the module and the chunks within those tiles are not responsible for holding up the structure above them and so, unlike conventional methods, the overall structure is stable and does not eventually collapse under its own weight.

When a module is in the full simulation mode 304, all the tiles within a module are set to active and are simulated individually (i.e. the proxy representation of the module is not used at all), e.g. in the same manner as conventional simulation systems.

The computational expense of a large-scale simulation depends on the number of modules that are in each of the modes. There is little computational expense associated with a module in inactive mode because the module is not animated in any way. The computational expense is increased when a module transitions from inactive module to one of the proxy modes; however, the increase may be limited because the module is treated as a single object (and not a collection of pre-fractured tiles). Both of the proxy modes described herein may vary significantly in terms of required computation depending upon the particular situation within the simulation and may range from zero computation (like inactive mode) almost up to full computation (like full simulation mode). There may be a large increase in computational expense when a module transitions from simulation proxy mode to full simulation mode because each tile within a module is simulated individually (and this mode always uses full computation, unlike the proxy modes). Despite the variation in computational expense of the proxy modes, by controlling (e.g. limiting) the number of modules in full simulation mode, the amount of computational capacity that is required can be limited (e.g. to match the available computational resources).

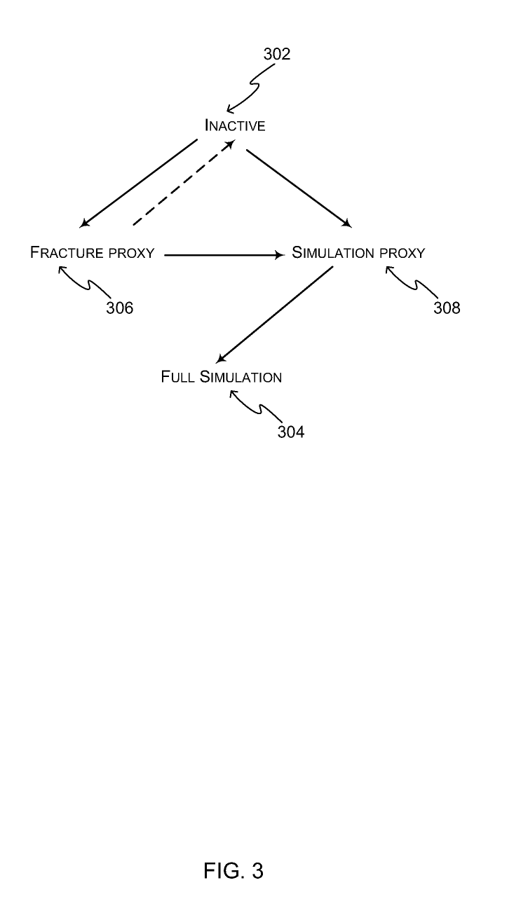

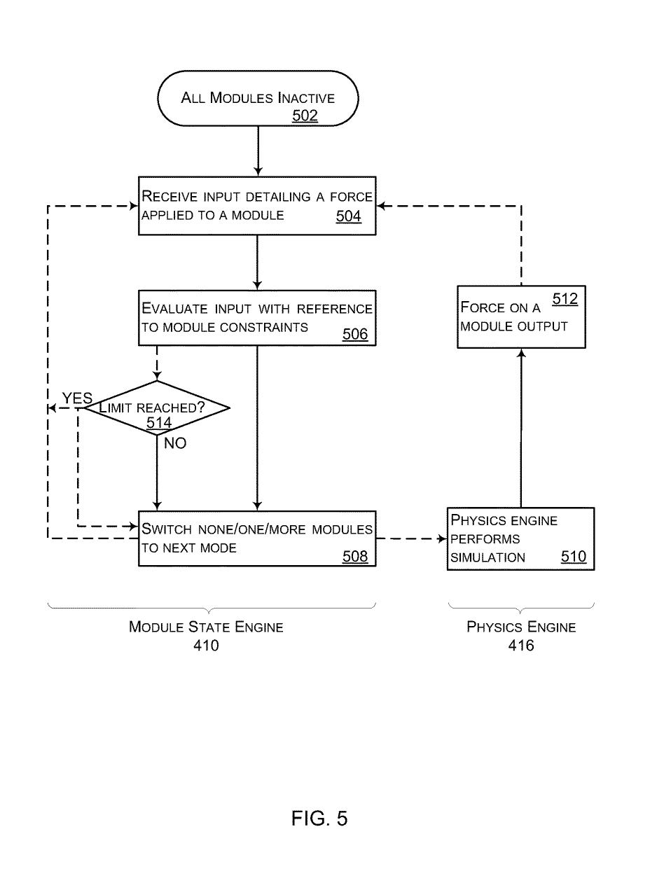

Initially all modules may be in inactive mode (i.e. at the start of a simulation) and then based on inputs received, a module state engine may update the mode of one or more modules within a large structure, e.g. so that one or more modules transition from the inactive mode to one of the proxy modes, and this is described in more detail below with reference to FIG. 5. Similarly the module state engine may then update the mode of one or more of the modules in a proxy mode 306, 308 to the full simulation mode 304. When (or if) transitioning mode, modules transition between modes as indicated by the solid arrows in the diagram in FIG. 3, i.e. from inactive 302 to one of the proxy modes and subsequently to full simulation (where, as shown, the transition may be via only simulation proxy mode 308 or via fracture proxy mode 306 and then simulation proxy mode 308).

For example, when simulating a building collapse, all the modules will start in inactive mode 302. Initially modules corresponding to the lower floors of the building may be transitioned through simulation proxy mode 308 and to full simulation mode 304 and in this mode, the tiles can fragment into the individual chunks. In order that the upper floors can start to fall, the corresponding modules are transitioned into simulation proxy mode 308 and the proxy representations are used to simulate the modules falling towards the ground and the modules may remain in simulation proxy mode whilst the modules are in the air. When a module impacts against the ground (or rubble from lower floors on the ground which is formed from fragments of the modules corresponding to those lower floors) they are transitioned into full simulation mode 304.

In another example, when simulating projectiles being fired at a building, all the modules will start in inactive mode 302. Modules corresponding to the impact area may be transitioned into fracture proxy module 306, e.g. so that fragments can break off and the rest of the building will remain static. If the bombardment triggers building collapse, modules corresponding to the impact area may then transition through simulation proxy mode to full simulation mode and modules outside of the impact area may transition from inactive through simulation proxy mode to full simulation mode (e.g. as described above).

In examples where an optional superstructure is used to provide additional rigidity to a module (as described above), the superstructure is inactive whilst the module is in the inactive or fracture proxy modes. If the module transitions into proxy simulation or full simulation mode, the superstructure also transitions into a full simulation mode.

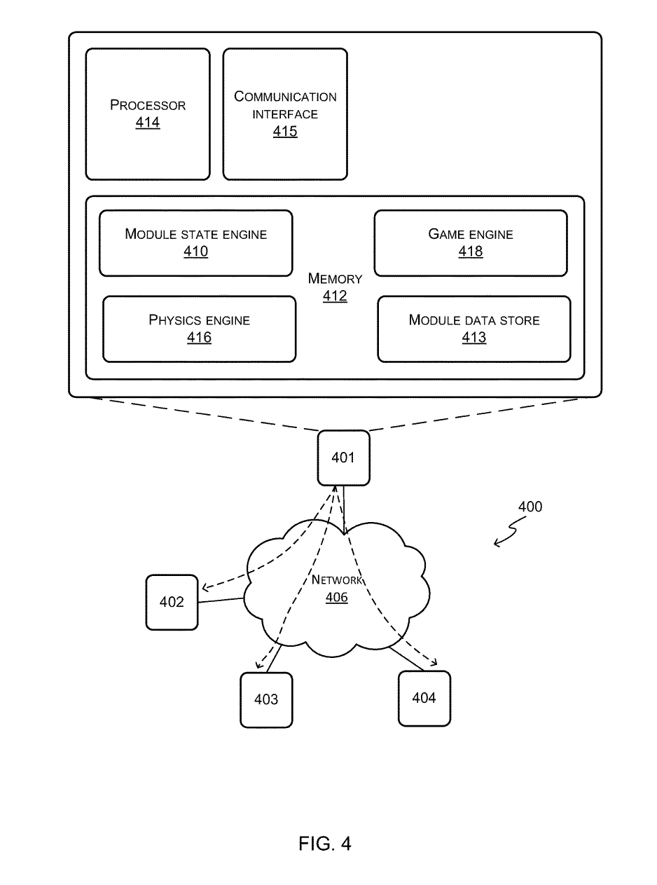

As well as reducing the computational expense, use of modules (and their proxy representations) as described herein additionally reduces the bandwidth required to synchronize the simulation between multiple computation devices and an example system is shown in FIG. 4. The system 400 comprises a plurality of computation devices 401-404 interconnected by a network 406 where in the example shown one device 401 is a central server (e.g. a cloud based gaming server which may be located in a data center) and the other devices 402-404 are client devices (e.g. home computing devices such as games consoles, laptop computers, tablets, smartphones, etc.). Alternatively the system may be a peer-to-peer system comprising multiple clients and no central server.

In order to synchronize simulations which are being performed separately on each of the computation devices transform data for each simulated object (e.g. the object's current position, rotation and scale) is distributed from the master device (e.g. central server 401) to the slave devices (e.g. the client devices 402-404) as indicated by the dotted arrows in FIG. 4. When in inactive mode 302, no transform data is transmitted for a module. When in fracture proxy mode 306 transform data (i.e. updated state) is only transmitted for the pieces that have fractured off the module, when in simulation proxy mode 308, a single set of transform data (for the proxy representation of the module) is transmitted and when in full simulation mode 304, transform data for each chunk (or fragment) in each of the tiles within the module is transmitted. Consequently, by controlling (e.g. limiting) the number of modules in full simulation mode, the amount of bandwidth that is required can be limited and in various examples this may be controlled to match the available bandwidth of a client device with the lowest available bandwidth. In addition, or instead, the number of modules in fracture proxy mode may be controlled (e.g. limited).

In some implementations it may also be possible for modules to transition between modes in the opposite direction to the transitions described above, i.e. from fracture proxy mode 306 back to inactive 302, as indicated by the dotted arrow in FIG. 3.

In various examples it may be possible for modules to transition from any state to any other state (i.e. such that they are not bound by the transitions indicated by arrows in FIG. 3). There are a number of ways that this may be implemented and two examples are described below.

In a first example implementation, to enable a module (or part thereof) to transition from full simulation mode 304 back to a proxy simulation mode 306, 308, a spatial hierarchy (such as a bounding volume hierarchy) of the pieces may be maintained (e.g. by the module state engine 410). If any two children in the hierarchy are sufficiently far apart, but none of their respective children are, each of the children in a module may be examined (e.g. by the module state engine 410) to determine if they have all come to rest. If they have all come to rest, the module and its proxy representations may be dynamically rebuilt into two or more modules, where the rested and proximate children are grouped into one or more modules in a proxy or inactive mode and any remaining moving children are part of one or more other modules which remain in the full simulation mode 304. This analysis and rebuilding of modules may be applied recursively in order to rebuild modules which comprise at least a pre-defined minimum number of chunks (e.g. to avoid having many very small modules which then reduces the computational and/or bandwidth savings achieved by using the proxy or inactive modes).

In a variation on this first example implementation, the condition that all the children have come to rest (before the module and its proxy representations are dynamically rebuilt) may be relaxed and instead, an alternative condition that fracturing and constraint breaking has stopped may be used. In this example, the module and its proxy representations may be dynamically rebuilt while the pieces are in motion, however, you would need to perform it again if any further significant destruction happened.

In a second example implementation, a connectivity graph of all the modules (i.e. which ones are connected to others and the position of those connections/constraints) may be updated as the pieces move. This graph may be analyzed to detect groups of pieces that become separated from this graph, and in response to detecting a group that has become separated, a new separate graph may be built for these pieces and other pieces they are connected to.

In an example, if there is a tall tower formed from 3 modules and somehow it gets split directly down the middle, one half is kept as the original graph of 3 modules, and another similar graph is built for the other 3 ‘sections’ (as they are not modules yet) and then module state can be created for the ‘sections’ (at which point they become modules).

A new set of module constraints (e.g. activation rules/thresholds) may be generated for the new graph and these may be generated from the module constraints in the original module graph, although the precise values may differ (e.g. if an original threshold is based off mass, this new graph would contain far less mass than the original building and might never be able to reach that original threshold).

The analysis of the graph (as described above) may be performed whilst the pieces are in motion but once fracturing and constraint breaking has stopped. However, where a new graph/module is generated while the pieces are in motion, it would need to be performed again if any further significant destruction happened.

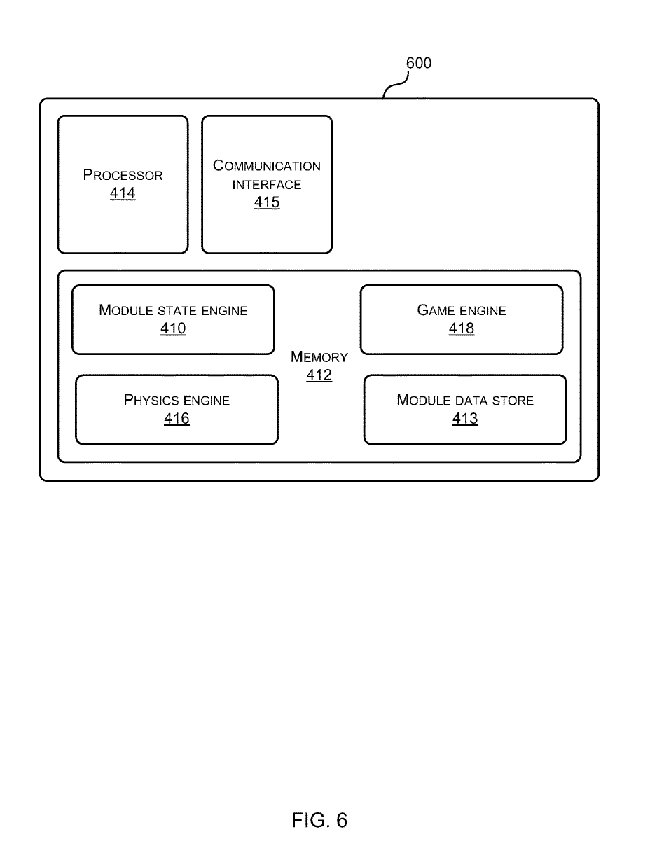

The master computing device (e.g. central server 401) in the system shown in FIG. 4 includes the module state engine 410 which controls the state of each module in a structure (e.g. by setting/changing flags and shape settings on the physics bodies which then affects the rigid body simulation performed by the physics engine 416). The methods and module state engine 410 described herein may also be implemented in a standalone computing device (e.g. a games console, laptop computer, tablet or smartphone) 600 as shown in FIG. 6. The module state engine 410 may, for example, be implemented in software and stored in memory 412. The module data 413 may also be stored in the memory 412 or may be stored external to the computing device 401, 600 and accessed via a communication interface 415. The operation of the module state engine 410, when executed by a processor 414 within the computing device 401, 600 can be described with reference to FIG. 5.

Initially all the modules in a structure (e.g. a house-sized structure comprising two or three modules or a large building comprising tens of modules) may be in inactive mode (block 502). The module state engine 410 receives an input (e.g. from a physics engine 416 or game engine 418) which defines a force applied to a module (block 504) and may also comprise data about the event which causes the force. The module state engine 410 evaluates this input using various module state constraints associated with the particular module to which the force is applied (block 506). These module state constraints may include both intra-module state constraints and inter-module state constraints. The constraints may be stored as part of the module data 413.

The intra-module state constraints for a module may comprise one or more thresholds defining a level of force which triggers a change of mode for the module and these thresholds may be different for the different mode transitions. For example, the threshold to transition from inactive to a proxy mode may be quite low and the threshold to transition from proxy mode to full simulation may be considerably higher (and may be dependent upon what the particular module represents). The intra-module state constraints may also specify one or more events or event types which may trigger a mode transition (e.g. into fracture proxy mode) even where a threshold (as described above) is not met or exceeded. These events may be linked to the gameplay (e.g. a particular type of projectile, a vehicle collision) and/or be generated by the physics engine (e.g. a ‘fracture’ notification from the physics engine). The thresholds which are specified in the intra-module constraints may be fixed or may be dynamic (e.g. they may be updated based on the force applied to a module as part of the evaluation in block 506). In this way a module may be weakened by a first applied force (as detailed in a first input received in block 504 resulting in a reduction in a threshold in block 506), such that a subsequent, lower applied force can then trigger the module to switch to a next mode.

The inter-module state constraints may define links between the states of two or modules. For example, two modules either side of a bridge may be linked by an inter-module state constraint which specifies that they always share the same state.

In response to performing the evaluation (in block 506), none, one or more modules are switched to the next mode (block 508), e.g. from inactive to fracture proxy mode or simulation proxy mode, from fracture proxy mode to simulation proxy mode or from simulation proxy mode to full simulation mode (e.g. as indicated by the solid arrows in FIG. 3). In examples where there are more than two proxy simulation modes, the module state engine 410 may comprise logic to decide which of the various proxy simulation modes available is most suitable for each module and then transition the module to that mode or to the full simulation mode.

The method may then be repeated for further applied forces where these forces may be applied by objects external to the structure (e.g. by a projectile which hits the structure) or may be propagated from one module to another (within the physics engine 416).

The operation of the module state engine 410 as described above (e.g. in blocks 504-508) impacts the operation of the physics engine 416 because it determines the number of objects which are considered by the physics engine when simulating the impact on the structure (block 510), e.g. by setting/changing flags and shape settings on the physics bodies, as described above. When all the modules in the structure are in inactive mode, the bodies (e.g. tiles) within a module are not simulated (e.g. they are ‘static’ in terminology used by the Havok physics engine) but a projectile or other object can collide with the bodies in the structure. When a module is in simulation proxy mode, the root shapes only of each tile are simulated and when in full simulation mode, tiles are activated and simulated at full detail. When a module is in fracture proxy mode, the root shapes are not simulated and only those chunks which are fractured off and separated from the module are simulated (and these chunks are simulated as if in full simulation mode). As more modules transition into other modes, the number of objects that the physics engine 416 simulates increases to a maximum value when all the modules are in full simulation mode. The inputs to the module state engine 410 (in block 504) may be generated by the physics engine 416 (block 512) and so there may be a chain reaction (similar to what happens when a structure collapses in the real world) with the fragmentation of one object (e.g. a pre-fractured tile) creating many further projectiles which impact on other objects and trigger their fragmentation.

Although the physics engine 416 and game engine 418 are shown as part of the central server 401 in FIG. 4, it will be appreciated that they may be run on other/separate servers. For example, the functionality of the central server 401 as shown in FIG. 4 may be distributed across multiple servers, with one or more servers running the physics engine 416 and one or more servers running the game engine 418 and the module state engine 410, or the module state engine 410 may run on a server which does not run either the game engine 418 or the physics engine 416. Furthermore, in various examples, the module state engine 410 may be integrated within the game engine 418.

As described above, there may be a limit on the number of modules that can be in the full simulation mode at any time and in various examples there may also be a limit on the number of modules that can be in a proxy mode at any time (e.g. one or both of the two proxy modes), although, as described above, the additional processing capacity that is required when a module transitions from inactive to a proxy mode is small. The limit on the number of modules that can be in full simulation mode at any time may be set based on the available computing resources and/or the available bandwidth for performing synchronization. As a result the limits may be fixed (e.g. for a single computing device implementation as shown in FIG. 6 where the computational resources are fixed and there is no need to perform any synchronization across a network) or may be variable. Where the limits are variable they may be set by the module state engine 410 or the game engine 418 or by another entity.

Where such limits are used, an additional operation (block 514) may be introduced into the method of FIG. 5. Having evaluated the applied force (as detailed in the input received in block 504) against the module state constraints (in block 506), which identifies which modules should in principle be changed to their next mode (in block 508), the limits for the number of modules in a mode are checked (in block 514), where these limits may be specified for all of the modes or for only a proper subset of the modes (e.g. only for the full simulation mode). If the limits will not be exceeded by the change identified (‘No’ in block 514), then that change occurs (in block 508). If, however, a limit will be exceeded by the proposed change (as identified in block 506), the mode change may not be performed (block 508 may be omitted) or alternatively other modules may be changed back to a previous mode, where possible (e.g. as indicated by the dotted arrows in FIG. 3) in order that the proposed change (as identified in block 506) can be implemented (in block 508).

When operating at or close to a limit (i.e. a limit on the number of modules that can be in a particular mode at the same point in time), the module state engine 410 may select which modules (from the proposed change identified in block 506) change mode and which do not change mode at this time, i.e. the proposed change (identified in block 506) may be partially implemented in some situations. The decision about which parts of a proposed change to implement (i.e. which modules identified in the proposed change will change mode and which will not) may be made based on a number of factors, where these factors may include one or more of: where users are within the simulated environment, what they are looking at (e.g. where the simulation is part of a multi-player experience such as a multi-player computer game), which modules are most relevant to current gameplay, etc.

In the methods as described above, the changing of modes (in block 508) is based on inputs (received in block 504) which define forces applied to modules and also based on module state constraints. In various examples other inputs may also be provided to the module state engine 410 and these may also be used in determining if and/or when a module changes mode. Examples of further inputs which may be used in this determination include inputs from the game engine 418 which may, for example, relate to the gameplay (e.g. to enable the simulation to be synchronized to a sound track).

Although the present examples are described and illustrated herein as being implemented in a networked (or cloud-based) system as shown in FIG. 4 or a standalone computing device as shown in FIG. 6, the systems described are provided as examples and not limitations. As those skilled in the art will appreciate, the present examples are suitable for application in a variety of different types of systems.

Furthermore, although the methods and module state engine are described above with reference to pre-fractured objects, the techniques may also be applied in combination with dynamic fracturing of objects. Where dynamic fracturing is used, the resulting dynamic fracture data (as generated on the server) may be transmitted to the client or alternatively data to enable to client to perform the same fracture may be transmitted to the client.

Using the methods and module state engine 410 described herein, extremely large objects can be created that require a comparatively small amount of processing, can maintain their shape even with forces such as gravity applied to them, and their destruction can still be simulated to a high fidelity of chunk size (i.e. to very small detailed chunks) and all without the need to send geometry data over the network.

As shown in FIGS. 4 and 6, computing-based device 401, 600 comprises one or more processors 414 which may be microprocessors, controllers or any other suitable type of processors for processing computer executable instructions to control the operation of the device in order to implement the method shown in FIG. 5. In some examples, for example where a system on a chip architecture is used, the processors 414 may include one or more fixed function blocks (also referred to as accelerators) which implement a part of the method of FIG. 5 in hardware (rather than software or firmware). For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The computer executable instructions, such as the module state engine 410, physics engine 416 and game engine 418 may be provided using any computer-readable media that is accessible by computing based device 401, 600. Computer-readable media may include, for example, computer storage media such as memory 412 and communications media. Computer storage media, such as memory 412, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 412) is shown within the computing-based device 401, 600 it will be appreciated that the storage may be distributed or located remotely and accessed via a network or other communication link (e.g. using communication interface 415).

The computing-based devices 401, 600 may also comprise features not shown in FIGS. 4 and 6. For example, the computing-based device 600 shown in FIG. 6 may further comprise an input/output controller arranged to output display information to a display device which may be separate from or integral to the computing-based device 600. The display information may provide a graphical user interface. The input/output controller may also be arranged to receive and process input from one or more devices, such as a user input device (e.g. a mouse, keyboard, camera, microphone or other sensor). In some examples the user input device may detect voice input, user gestures or other user actions and may provide a natural user interface (NUI). This user input may be used to provide user inputs to move a player within the simulated environment. In an embodiment the display device may also act as the user input device if it is a touch sensitive display device. The input/output controller may also output data to devices other than the display device, e.g. to speakers, headphones, a locally connected printing device, etc.

Any of the input/output controller, display device and the user input device may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

A first further example provides a computing device comprising: a processor; an input configured to receive data describing a large structure, the data identifying one or more modules and a plurality of pre-fractured tiles, each module corresponding to an arrangement of some or all of the pre-fractured tiles and the data comprising one or more module state constraints; a memory; and a module state engine stored in the memory and comprising computer executable instructions which, when executed by the processor, cause the processor, in response to receiving an input defining a force and/or an event applied to a module in the large structure, to update a mode associated with none, one or more of the modules in the large structure based on the input and one or more of the module state constraints, wherein the mode associated with a module is selected from a set of modes comprising an inactive mode in which a rigid body representation of the entire module is not animated by a physics engine, a full simulation mode in which the tiles within the module are simulated individually by the physics engine and at least one of a fracture proxy mode and a simulation proxy mode, wherein in the fracture proxy mode, the rigid body representation of the entire module is not animated by the physics engine but a tile within the module can fracture into chunks, and in the simulation proxy mode, the module is simulated as a single rigid body by the physics engine and tiles within the module cannot fracture into chunks.

The module state engine may further comprise computer executable instructions which, when executed by the processor, cause the processor to generate an output for input to the physics engine, wherein the output is dependent upon the current mode of each module in the large structure.

The module state engine may further comprise computer executable instructions which, when executed by the processor, cause the processor to maintain a limit on how many modules are in full simulation mode at any point in time. The computing device may further comprise a game engine stored in the memory and comprising computer executable instructions which, when executed by the processor, cause the processor to set the limit based on available computation capacity for executing the physics engine.

The computing device may further comprise a data store arranged to store module data, the module data comprising, for each module, the rigid body representation of the module and one or more module state constraints.

The computing device may be a central server and may further comprise a communication interface configured to communicate with other servers or a plurality of client computing devices.

A second further example provides a method of simulating large structures comprising: accessing a data store comprising data describing a large structure, the data identifying one or more modules and a plurality of pre-fractured tiles, each module corresponding to an arrangement of some or all of the pre-fractured tiles and the data comprising one or more module state constraints; receiving an input defining a force and/or an event applied to a module in the large structure; and updating a mode associated with none, one or more of the modules in the large structure based on the input received and one or more of the module state constraints, wherein the mode associated with a module is selected from a set of modes comprising an inactive mode in which a rigid body representation of the entire module is not animated by a physics engine, a full simulation mode in which the tiles within the module are simulated individually by the physics engine and at least one of a fracture proxy mode and a simulation proxy mode, wherein in the fracture proxy mode, the rigid body representation of the entire module is not animated by the physics engine but a tile within the module can fracture into chunks, and in the simulation proxy mode, the module is simulated as a single rigid body by the physics engine and tiles within the module cannot fracture into chunks.

The method may further comprise: outputting data to the physics engine for each module, the data output for a module being dependent upon the mode associated with the module.

Updating a mode associated with none, one or more of the modules in the large structure may comprise: evaluating the input received with reference to one or more module state constraints associated with the module to which the force is applied; and updating a mode associated with none, one or more of the modules in the large structure based on an outcome of the evaluation.

Evaluating the input received may comprise: comparing an applied force to a threshold force defined by a module state constraint; and in response to determining that the threshold force is exceeded, updating a mode associated with the module to which the force is applied.

Evaluating the input received may comprise: updating a mode associated with a module based on an event defined in the input and a module state constraint. Updating a mode associated with none, one or more of the modules in the large structure may further comprise: controlling a number of modules in the full simulation mode at any time such that a limit is not exceeded.

The method may further comprise: setting the limit on the number of modules in the full simulation mode based on available computation resources.

The method may be implemented in a server in a system, wherein the server is connected to a plurality of client computing devices and the method may further comprise: setting the limit on the number of modules in the full simulation mode based on an available bandwidth to one of the client computing devices.

A third further example provides a system comprising: a data store configured to store data describing a large structure, the data identifying one or more modules and a plurality of pre-fractured tiles, each module corresponding to an arrangement of some or all of the pre-fractured tiles and the data comprising one or more module state constraints; and a module state engine configured, in response to receiving an input defining a force and/or an event applied to a module in the large structure, to update a mode associated with none, one or more of the modules in the large structure based on the input received and one or more of the module state constraints, wherein the mode associated with a module is selected from a set of modes comprising an inactive mode in which a rigid body representation of the entire module is not animated by a physics engine, a simulation proxy mode in which the rigid body representation can be animated by the physics engine and a full simulation mode in which the tiles within the module are simulated individually by the physics engine.

In a variation of the third further example, the simulation proxy mode tiles within the module cannot fracture into chunks and the set of modes further comprising a fracture proxy mode in which rigid body representation of the entire module is not animated by the physics engine but a tile within the module can fracture into chunks.

The module state engine may be further configured to generate an output for input to the physics engine, wherein the output is dependent upon the current mode of each module in the large structure.

The system may further comprise the physics engine.

The module state engine and/or the physics engine in the system may be at least partially implemented using hardware logic selected from any one or more of: a field-programmable gate array, a program-specific integrated circuit, a program-specific standard product, a system-on-a-chip, a complex programmable logic device.

The module state engine may be further configured to maintain a limit on how many modules are in full simulation mode at any point in time.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computing device comprising:
a processor;
an input configured to receive data describing a large structure, the data identifying one or more modules and a plurality of pre-fractured tiles, each module corresponding to an arrangement of some or all of the pre-fractured tiles and the data comprising one or more module state constraints;
a memory; and
a module state engine stored in the memory and comprising computer executable instructions which, when executed by the processor, cause the processor, in response to receiving an input defining a force and/or an event applied to a module in the large structure, to update a mode associated with none, one or more of the modules in the large structure based on the input and one or more of the module state constraints,
wherein the mode associated with a module is selected from a set of modes comprising an inactive mode in which a rigid body representation of the entire module is not animated by a physics engine, a full simulation mode in which the tiles within the module are simulated individually by the physics engine and at least one of a fracture proxy mode and a simulation proxy mode, wherein in the fracture proxy mode, the rigid body representation of the entire module is not animated by the physics engine but a tile within the module can fracture into chunks, and in the simulation proxy mode, the module is simulated as a single rigid body by the physics engine and tiles within the module cannot fracture into chunks.

2. A computing device according to claim 1, wherein the module state engine further comprises computer executable instructions which, when executed by the processor, cause the processor to generate an output for input to the physics engine, wherein the output is dependent upon the current mode of each module in the large structure.

3. A computing device according to claim 1, wherein the module state engine further comprises computer executable instructions which, when executed by the processor, cause the processor to maintain a limit on how many modules are in full simulation mode at any point in time.

4. A computing device according to claim 3, further comprising a game engine stored in the memory and comprising computer executable instructions which, when executed by the processor, cause the processor to set the limit based on available computation capacity for executing the physics engine.

5. A computing device according to claim 1, further comprising a data store arranged to store module data, the module data comprising, for each module, the rigid body representation of the module and one or more module state constraints.

6. A computing device according to claim 1, wherein the computing device is a central server and further comprises a communication interface configured to communicate with other servers or a plurality of client computing devices.

7. A method of simulating large structures comprising:
accessing a data store comprising data describing a large structure, the data identifying one or more modules and a plurality of pre-fractured tiles, each module corresponding to an arrangement of some or all of the pre-fractured tiles and the data comprising one or more module state constraints;
receiving an input defining a force and/or an event applied to a module in the large structure; and
updating a mode associated with none, one or more of the modules in the large structure based on the input received and one or more of the module state constraints,
wherein the mode associated with a module is selected from a set of modes comprising an inactive mode in which a rigid body representation of the entire module is not animated by a physics engine, a full simulation mode in which the tiles within the module are simulated individually by the physics engine and at least one of a fracture proxy mode and a simulation proxy mode, wherein in the fracture proxy mode, the rigid body representation of the entire module is not animated by the physics engine but a tile within the module can fracture into chunks, and in the simulation proxy mode, the module is simulated as a single rigid body by the physics engine and tiles within the module cannot fracture into chunks.

8. A method according to claim 7, further comprising:
outputting data to the physics engine for each module, the data output for a module being dependent upon the mode associated with the module.

9. A method according to claim 7, wherein updating a mode associated with none, one or more of the modules in the large structure comprises:
evaluating the input received with reference to one or more module state constraints associated with the module to which the force is applied; and
updating a mode associated with none, one or more of the modules in the large structure based on an outcome of the evaluation.

10. A method according to claim 9, wherein evaluating the input received comprises:
comparing an applied force to a threshold force defined by a module state constraint; and
in response to determining that the threshold force is exceeded, updating a mode associated with the module to which the force is applied.

11. A method according to claim 9, wherein evaluating the input received comprises:
updating a mode associated with a module based on an event defined in the input and a module state constraint.

12. A method according to claim 9, wherein updating a mode associated with none, one or more of the modules in the large structure further comprises:
controlling a number of modules in the full simulation mode at any time such that a limit is not exceeded.

13. A method according to claim 12, further comprising:
setting the limit on the number of modules in the full simulation mode based on available computation resources.

14. A method according to claim 12, implemented in a server in a system, wherein the server is connected to a plurality of client computing devices and the method further comprising:
setting the limit on the number of modules in the full simulation mode based on an available bandwidth to one of the client computing devices.

15. A system comprising:
a data store configured to store data describing a large structure, the data identifying one or more modules and a plurality of pre-fractured tiles, each module corresponding to an arrangement of some or all of the pre-fractured tiles and the data comprising one or more module state constraints; and
a module state engine configured, in response to receiving an input defining a force and/or an event applied to a module in the large structure, to update a mode associated with none, one or more of the modules in the large structure based on the input received and one or more of the module state constraints,
wherein the mode associated with a module is selected from a set of modes comprising an inactive mode in which a rigid body representation of the entire module is not animated by a physics engine, a simulation proxy mode in which the rigid body representation can be animated by the physics engine and a full simulation mode in which the tiles within the module are simulated individually by the physics engine.

16. A system according to claim 15, wherein in the simulation proxy mode tiles within the module cannot fracture into chunks and the set of modes further comprising a fracture proxy mode in which rigid body representation of the entire module is not animated by the physics engine but a tile within the module can fracture into chunks.

17. A system according to claim 16, wherein the module state engine is further configured to generate an output for input to the physics engine, wherein the output is dependent upon the current mode of each module in the large structure.

18. A system according to claim 16, further comprising the physics engine.

19. A system as claimed in claim 18, the module state engine and/or the physics engine being at least partially implemented using hardware logic selected from any one or more of: a field-programmable gate array, a program-specific integrated circuit, a program-specific standard product, a system-on-a-chip, a complex programmable logic device.

20. A system according to claim 16, wherein the module state engine is further configured to maintain a limit on how many modules are in full simulation mode at any point in time.
